(19) United States
(12) Patent Application Publication
(10) Pub. No.: US 2014/0081512 A1
(43) Pub. Date: Mar. 20, 2014

(54) AIR BRAKE LINE AIRFLOW CONTROL DEVICE WITH WIRELESS CONTROLLER

(71) Applicant: Fugiel Railroad Supply Corp., Cary, IL (US)

(72) Inventors: Robert V. Fugiel, Cary, IL (US); Klaus Gunther Buchberger, Oconomowoc, WI (US)

(73) Assignee: Fugiel Railroad Supply Corp., Cary, IL (US)

(21) Appl. No.: 14/087,726

(22) Filed: Nov. 22, 2013

Related U.S. Application Data
(63) Continuation-in-part of application No. 12/930,292, filed on Jan. 3, 2011, now abandoned.

(51) Int. Cl. B60T 17/22

(52) U.S. Cl. CPC B60T 17/228
USPC 701/33.2; 701/34.4

(57) ABSTRACT

A system for testing the air brake line of a train consist includes an airflow control device connected between the air brake line and a source of compressed air in a train yard. The system further includes a portable handheld device and an end-of-train pressure monitor that are able to wirelessly communicate with the airflow control device by means of a repeater. An airflow sensor in the airflow control device is used while charging the air brake line and also to perform an Air Flow Method of brake line testing.

### CROSS-REFERENCE TO RELATED APPLICATIONS

This application is a Continuation of application Ser. No. 12/930,292, filed Jan. 3, 2011, which is a Continuation-in-Part of application Ser. No. 12/592,122, filed Nov. 19, 2009, which is a Continuation of application Ser. No. 11/408,748, filed Apr. 21, 2006.

### TECHNICAL FIELD

The present invention relates generally to air brake testing and more particularly to remote controlled testing of a railroad air brake line.

### BACKGROUND

A series of interconnected railcars is typically called a train consist. In a train consist, the air brake line of each railcar is connected to that of the railcars adjacent to it so as to form one continuous air brake line. A Federal Railroad Administration (FRA), regulation 49 CFR §232.201, requires testing of the air brake line of a train consist upon occurrence of various specified events. For example, when performed at the time a train consist is originally made up, the test is known as a Class I test. A Class IA test is performed after any railcar on the train has traveled not more than 1,000 miles from the location of its last Class I or Class IA brake test.

Air brake testing for railcars includes several components, including two alternative types of leakage tests: a brake pipe leakage test measuring air pressure loss over a period of time or an Air Flow Method Test measuring the air flow. Recently, the Air Flow Method, discussed in FRA rule 49 CFR 232.205 (c)(ii), has become a preferred method for testing brakes. In addition to testing the air brake as a whole, air brakes of each individual car are visually inspected. Visual inspection of the brakes is performed before and after a twenty pounds per square inch (PSI) air pressure reduction to determine whether the brakes work correctly on each car.

One way to test the brakes of a train consist is to connect it to a locomotive so that the apparatus in the locomotive used to control the brake line during operation of the train is used to test the brakes. This method is undesirable because it requires the locomotive crew to be present, resulting in extra manpower costs.

Alternatively, a train consist can be tested using an engineer's brake valve, essentially a pipe with some valves and a pressure gauge, which is connected between the brake line and a source of yard air. This method requires a person to be physically located near one or more valves that control the flow of air into or out of the air brake line. At a first time a valve is moved into a position that allows air to enter the air brake line from a source of compressed air. At a later time, after the air pressure level in the air brake line reaches a predetermined level (such as around ninety PSI), a valve is moved into a position that allows a release of air from the air brake line to reduce the air pressure in the air brake line by twenty PSI.

After charging and reducing the pressure, the carman walks the length of the train consist to verify that all brakes have been applied. Then, the brake line is again fully charged and the carman walks the length of the train consist again to check that the brakes have released on each car. In one example, the person who physically moves the valves is the same person who walks the length of the train consist to inspect the air brake line. As one shortcoming of this arrangement, that person must walk the length of the train consist at least four times to perform the air pressure reduction test.

In another example, one person physically moves the valves and another person walks the train consist to inspect the air brake line. In this case, however, multiple people are needed to perform the air pressure reduction test. Because of the considerable labor involved, it is desirable to remotely control the air pressure reduction test.

Attempts to use wireless communications to assist in brake testing have met with limited success. The conditions in a train yard are very challenging, with train lengths as much as two miles, interference from other communication systems, many large steel structures that block signals, and low power restrictions on the wireless units. The known systems and methods also do not perform an Air Flow Method test without using a locomotive.

### SUMMARY

A system constructed in accordance with the principles herein includes an apparatus for testing the brakes of a train consist. The system includes an airflow control device having a programmable controller, a portable, handheld device, an end-of-train (EOT) pressure monitor and a repeater. The airflow control device is disposed between a source of compressed air and an air brake line of a railcar at one end of a train consist. The EOT pressure monitor is connected to the brake line at the other end of the train consist. The airflow control device, handheld device and EOT pressure monitor communicate with each other wirelessly by means of the repeater.

The portable, handheld device is transportable by a user along the train consist during inspection of the air brake line, and is adapted to send signals to the programmable controller in the airflow control device that enable certain tasks to be performed by the programmable controller. For example, the signals received from the portable, handheld device can open and close valves as well as take pressure and airflow measurements. The airflow control device also includes a supply valve for controlling the flow of air between the source of compressed air and the brake line, as well as pressure and air flow sensors for communicating pressure and air flow measurements through the brake line to the programmable controller.

In an embodiment, a system for testing the brakes of a train consist is provided. An airflow control device has a programmable controller and an airflow sensor. The airflow sensor is used while initially charging the brake system, and to perform the Air Flow Method of brake testing, wherein the airflow sensor detects whether the airflow through the brake line is within predetermined limits for a period of time.

In another embodiment, a method for building a system for testing a brake line of a train consist is provided. In accordance with the method, valves within an airflow control device are operatively connected between a source of compressed air and an air brake line at one end of a train consist. A programmable controller is also operatively connected to the valves within the airflow control device. A portable handheld device in wireless communication with the programmable controller is provided for exchanging signals with the programmable controller. An end-of-train pressure monitor is operatively connected to the air brake line at the opposite end of the train consist from the airflow control device. The EOT pressure monitor can wirelessly communicate pressure data to the programmable controller. A repeater is provided for facilitating wireless communication between the controller, the handheld device and the end-of-train pressure monitor.

### DESCRIPTION OF THE DRAWINGS

FIG. 1A illustrates an embodiment of a system for testing air brakes in a train consist constructed in accordance with the principles herein.

FIG. 1B illustrates a more detailed view of the system of FIG. 1A.

FIG. 2 illustrates further details of an airflow control device shown in FIGS. 1A and 1B.

FIG. 3 illustrates further details of a hand-held controller shown in FIGS. 1A and 1B.

FIG. 4 illustrates further details of an end-of-train pressure monitor shown in FIGS. 1A and 1B.

### DESCRIPTION

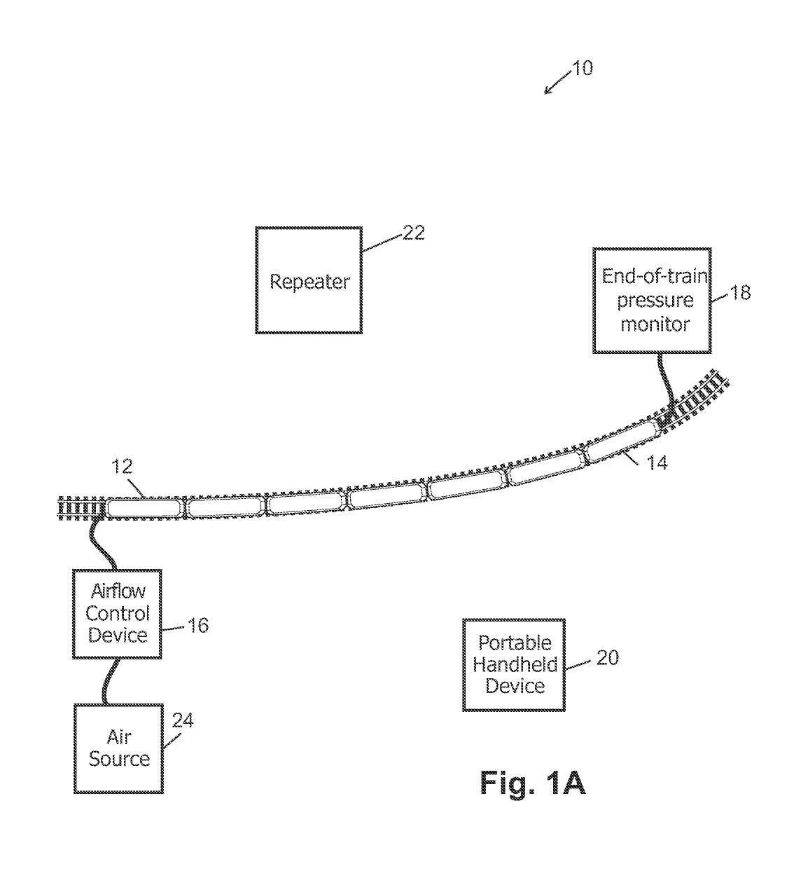

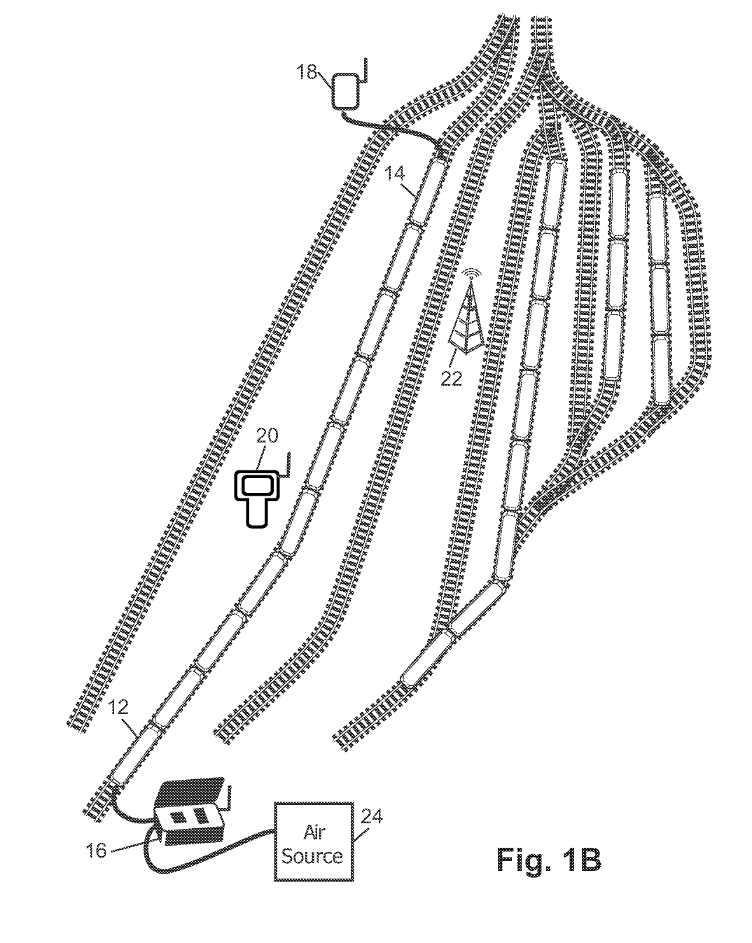

As illustrated in FIG. 1A, a suitable system, shown generally at 10 for testing the air brake line of a group of railcars, known as a train consist, in a train yard is set forth. A train consist includes a head-of-train car 12 and an end-of-train car 14. The air brake line of each car in the train consist is interconnected so as to form one continuous brake line from the start of the head of train car 12 to the end of end-of-train car 14.

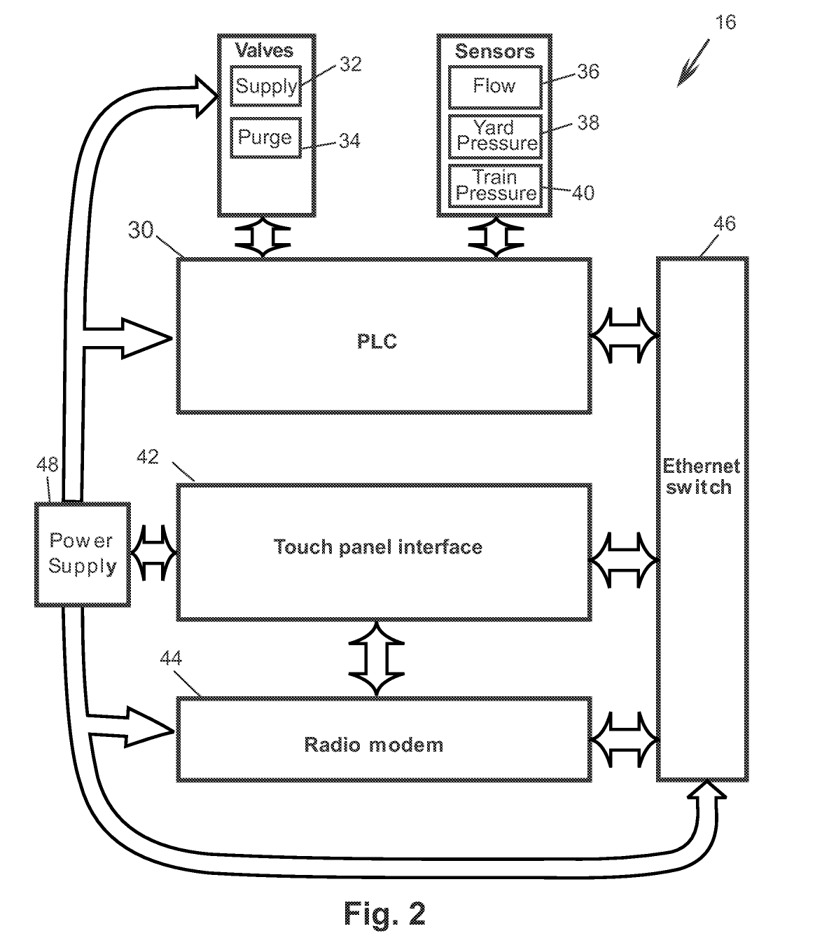

An airflow control device 16 is connected between an air brake line of the head of train car 12 and a compressed air source 24. As further described below in connection with FIG. 2, the airflow control device 16 includes valves and sensors for use in testing the brake line of the train consist. An end-of-train (EOT) pressure monitor 18 is connected to the end of the air brake line at the end of train car 14. The EOT pressure monitor 18 is in wireless communication with the airflow control device 16 so that air pressure at the end of the brake line in the end of train car 14 can be communicated to the airflow control device 16.

A portable hand-held device 20 is used to wirelessly communicate with the airflow control device 16. This allows a user of the system to control its operation either at the airflow control device 16 or with the hand-held device 20. A repeater 22 facilitates communication between the airflow control device 16, the EOT monitor 18 and a hand-held device 20.

The airflow control device 16 and the hand-held device 20 communicate through repeater 22. The repeater 22 receives and forwards wireless transmissions between a transceiver in the hand-held device 20 and a transceiver in the airflow control device 16 as well as a transceiver in the EOT monitor 18. All communication between the devices goes through the repeater 22.

FIG. 1B shows the system of FIG. 1A in context within a train yard. Elements with similar numbers are the same throughout the figures. A user of a system constructed in accordance with the principles herein would select a set of devices including, but not limited to an airflow control device 16, an end-of-train pressure monitor 14 and a hand-held device 20. All three devices include transceivers for communicating wirelessly.

In an embodiment, the transceivers could, for example, be Intuicom (manufactured by Freewave Technologies) Ethernet radios (EB3 Plus) using spread spectrum technology, but any suitable long-range, high speed industrial transceiver may be used. A user would then proceed to the head railcar 12 of a train consist and connect the airflow control device 16 between the head of the train car 12 and a yard compressed air source 24. Subsequently, the user would connect an end-of-train pressure monitor 18 to an end of train car 14. The airflow control device 16, the EOT pressure monitor 18 and the handheld device 20 are then powered on, enabling them to communicate with each other by means of the repeater 22. For long range transmissions, the repeater 22 allows the system to maintain an acceptable signal strength level along the communications path formed between airflow control device 16, the EOT pressure monitor 18 and the handheld device 20. This is particularly important as some train consists may be as much as two miles long. The repeater 22 can be advantageously placed on a tower located centrally in the train yard with an elevation of at least 80 feet. In an embodiment, a suitable repeater is an Intuicom (manufactured by Freewave) Ethernet radio (EB3 Plus) however any suitable long-range, high speed industrial repeater can be used.

After powering the devices on, the user would proceed to perform various brake tests. In particular, the user would be able to cause the air control device 16 to charge the air brake line, perform a reduction of 20 PSI in the air brake line, and perform leakage and Air Flow Method brake tests. A user would also be able to visually inspect the brakes of each railcar in the train consist and use the hand-held device 20 to control the charging to the brake line during the test.

The airflow control device 16 of a system constructed in accordance with the principles herein is shown in more detail in FIG. 2. The airflow control device 16 includes a programmable logic controller (PLC) 30 which controls the operation of all elements within the device 16. In an embodiment, PLC 30 can be, for example, a Siemens Simatic S7-1200 PLC but any suitable programmable logic device can be used. The function performed by PLC 30 could also be performed by a custom designed microprocessor controller, as discussed in both parent applications U.S. Ser. No. 11/408,748 and U.S. Ser. No. 12/592,122. A user of the airflow control device 16 may give commands to PLC 30 by means of touch panel interface 42 or remotely by means of a web server which is connected to device 16 by means of repeater 22.

An advantage of using a PLC in a system constructed in accordance with the principles herein is eliminating the need for custom designed circuit boards. In the event a repair is needed to the system, custom circuit boards are costly and time-consuming to repair. An off-the shelf PLC, on the other hand, is readily available and quick to replace, thereby improving the overall usability of the system.

During the operation of the airflow control device 16, the PLC 30 sends signals to a supply valve 32 and a purge valve 34 to control the flow of air from a compressed air source 24 to the train brake line. The PLC 30 is also connected to a flow sensor 36, a yard pressure transducer 38 and a train pressure transducer 40. Inputs from the sensors and transducers are received continuously and are used by the PLC 30 to control the operation of the valves 32 and 34 during various brake line tests.

For example, while charging the brake line, the PLC 30 first verifies all valves are closed. It then detects the specific air pressure generated by the yard air source 24 of FIG. 1B. A system constructed in accordance with the principles herein is capable of being operated with a yard air source providing compressed air at the standard 90 PSI, or any of a variety of less common air pressures, for example, 75 PSI.

Once the yard air pressure is determined, the PLC 30 opens the supply valve 32 and monitors the flow sensor 36 and the train pressure sensor 40 for certain specific conditions. For example, once the flow sensor 36 has detected that air flow through the brake line has decreased below a certain amount, the PLC 30 checks the train pressure sensor 40 to make sure the brake line air pressure is within 2 PSI of the yard pressure. The PLC 30 then displays a “train charged” indicator.

The airflow control device 16 also includes a touch panel interface 42. The touch panel interface 42 allows a user of the system 10 to cause the PLC 30 to perform various tests and see the results of those tests. In an embodiment, the touch panel 42 can include any suitable touch panel, such as, for example, a Siemens Simatic HMI. A radio modem 44 is a transceiver which allows the airflow control device 16 to communicate with the hand-held device 20 and the EOT monitor 18 by means of the repeater 22 as shown in FIG. 1B. The PLC 30, the touch panel 42 and the radio modem 44 are all connected to an Ethernet switch 46 for the purposes of communicating data and commands within the airflow control device 16. Finally, a power supply 48 provides power for all components of the device 16.

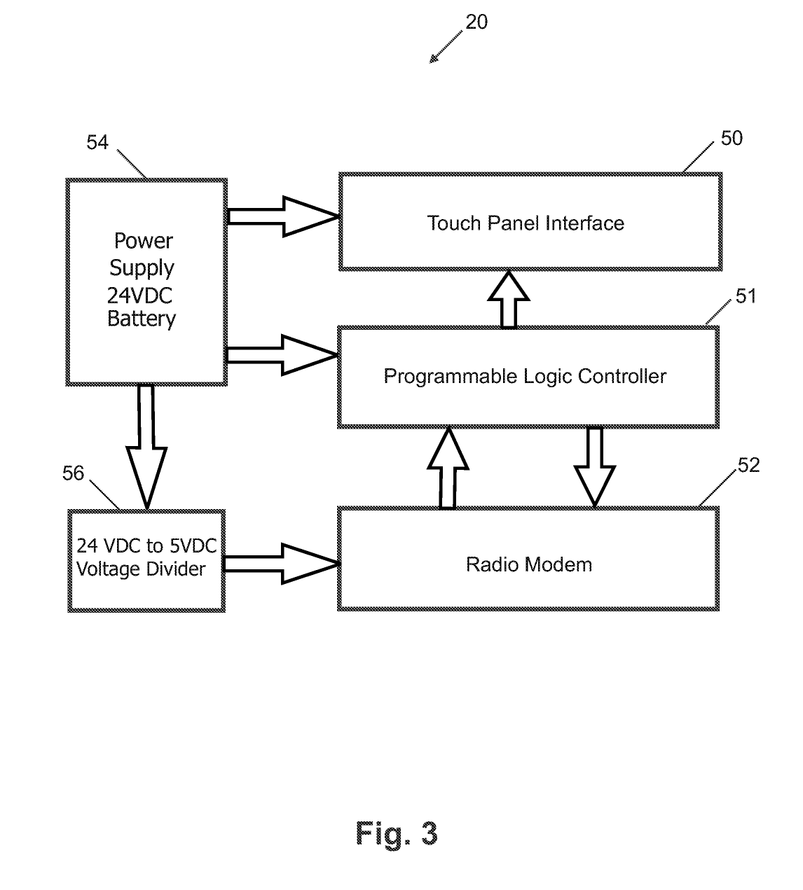

The hand-held device 20 is shown in more detail in FIG. 3. The hand-held device 20 includes a touch panel interface 50 and a programmable logic controller 51 which are similar to the touch panel interface 42 and PLC 30 in airflow control device 16 shown in FIG. 2. The touch panel interface 50 is used to interact with PLC 51 and cause it to communicate with the airflow control device 16 via the radio modem 52 and the repeater 22 from FIG. 1. A power supply 54 provides 24 VDC power to the touch panel interface 50 and PLC 51. A voltage divider 56 takes 24 VDC power from the power supply 54, converts it to 5 VDC power and sends it to the radio modem 52.

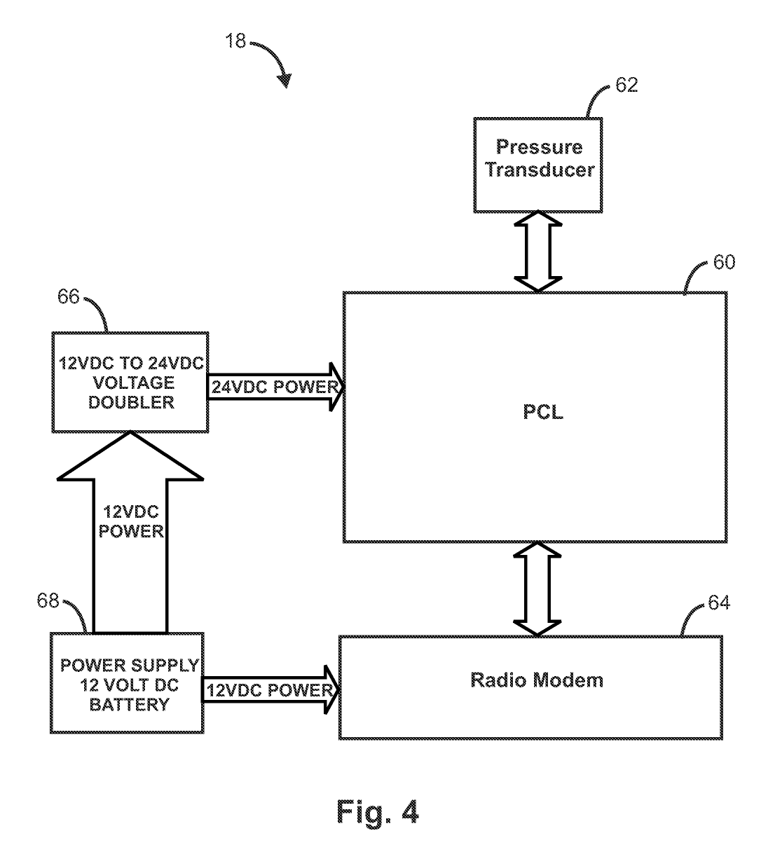

FIG. 4 provides further details of a suitable EOT pressure monitor, such as the EOT pressure monitor 18 of FIG. 1B. The EOT pressure monitor 18 includes a programmable logic controller (PLC) 60 for controlling the operation of the EOT monitor 18. The PLC 60 is connected to a pressure transducer 62, which detects the pressure at the end of the air brake line in the end-of-train car 14 of FIG. 1. The EOT monitor 18 wirelessly communicates this information to the airflow control device 16 via the radio modem 64 and repeater 22 of FIG. 1B. A power supply 68 provides 12 VDC power to the radio modem 64. A voltage doubler 66 takes 12 VDC power from the power supply 68, converts it to 24 VDC power and sends it to the PLC 60. In an embodiment, PLC 60 can be, for example, a Siemens Simatic S7-1200 PLC but any suitable programmable logic device can be used.

Although embodiments of the invention have been depicted and described in detail herein, it will be apparent to those skilled in the relevant art that various modifications, additions, substitutions, and the like can be made without departing from the spirit or the invention and these are therefore considered to be within the scope of the invention as defined in the following claims.

1. A system for testing the brakes of a train consist comprising:
an airflow control device connected between a source of compressed air and an air brake line of a railcar at one end of a train consist;
a programmable controller within said airflow control device allowing user-controlled operation of said device;
a portable, handheld device in wireless communication with said programmable controller so that a user may operate said programmable controller remotely in addition to operating said programmable controller at the airflow control device;
an end-of-train pressure monitor connected to an air brake line of a railcar at the opposite end of said train consist from said airflow control device, said monitor wirelessly communicating pressure data to the programmable controller; and
a repeater for facilitating wireless communication between said airflow control device, said handheld device and said end-of-train pressure monitor.

2. The system of claim 1 wherein said airflow control device further includes:
a supply valve within said airflow control device and controlled by said programmable controller, for controlling the flow of air between said source of compressed air and said brake line;
a pressure sensor within said airflow control device and in communication with said programmable controller for detecting the air pressure of said brake line; and
an airflow sensor within said airflow control device and in communication with said programmable controller for detecting the airflow through said brake line.

3. The system of claim 1 wherein said source of compressed air is a stand-alone air compressor.

4. The system of claim 1 wherein said wireless communication uses a TCP/IP or Ethernet protocol.

5. The system of claim 1 wherein the airflow control device includes a touch screen display used to enter commands controlling the operation of the programmable controller.

6. The system of claim 5 wherein the handheld device includes a touch screen display used to wirelessly send commands to the programmable controller of the airflow control device.

7. The system of claim 1 wherein said repeater is located in a central area of a train yard where said train consist is being tested, at an elevation of at least 80 feet above the ground.

8. The system of claim 1 wherein each of the airflow control device, the handheld device and the end-of-train pressure monitor include a long-range, high speed, industrial transceiver using spread spectrum technology to perform said wireless communication.

9. A system for testing the brakes of a train consist comprising:
an airflow control device connected between a source of compressed air and an air brake line of a railcar at one end of a train consist;
a programmable controller within said airflow control device allowing user-controlled operation of said device; and
an airflow sensor within said airflow control device and in communication with said programmable controller for detecting the airflow through said brake line wherein said airflow sensor detects whether the airflow is within predetermined limits for a period of time indicating that the brakes have been tested successfully.

10. A system according to claim 9 further comprising:
a portable handheld device in wireless communication with said programmable controller so that a user may operate said programmable controller remotely in addition to operating said programmable controller at the airflow control device;
an end-of-train pressure monitor connected to an air brake line of a railcar at the opposite end of said train consist from said airflow control device, said monitor wirelessly communicating pressure data to the programmable controller; and
a repeater for facilitating wireless communication between said airflow control device, said handheld device and said end-of-train pressure monitor.

11. The system of claim 9 wherein said source of compressed air is a stand-alone air compressor.

12. The system of claim 9 wherein said wireless communication uses a TCP/IP or Ethernet protocol.

13. The system of claim 9 wherein the airflow control device includes a touch screen display used to enter commands controlling the operation of the programmable controller.

14. The system of claim 13 wherein the handheld device includes a touch screen display used to wirelessly send commands to the programmable controller of the airflow control device.

15. A method of forming a system for testing the brake line of a train consist comprising:
operatively connecting an airflow control device between a source of compressed air and an air brake line of a railcar at one end of a train consist;
operatively connecting a set of valves and sensors within said airflow device to control and monitor the flow of air from the source of compressed air to the brake line;
operatively connecting a programmable controller to said valves and sensors so as to allow user-controlled operation of the airflow control device;
providing a portable, handheld device in wireless communication with said programmable controller so that a user may operate said programmable controller remotely in addition to operating said programmable controller at the airflow control device;
operatively connecting an end-of-train pressure monitor to an air brake line of a railcar at the opposite end of said train consist from said airflow control device, said monitor wirelessly communicating pressure data to the programmable controller; and
providing a repeater for facilitating wireless communication between said airflow control device, said handheld device and said end-of-train pressure monitor.

16. A method according to claim 15 further comprising the steps of:
operatively connecting a touch screen display to the programmable controller such that a user may enter commands controlling the operation of the programmable controller.

17. A method according to claim 15 further comprising the steps of:
locating said repeater in a central area of a train yard where said train consist is being tested, at an elevation of at least 80 feet above the ground; and
providing each of the airflow control device, the handheld device and the end-of-train pressure monitor with a long-range, high speed, industrial transceiver using spread spectrum technology to perform said wireless communication.
